(19) United States
(12) Patent Application Publication
(10) Pub. No.: US 2017/0277776 A9
(43) Pub. Date: Sep. 28, 2017

(54) SYSTEM AND METHOD FOR RECEPTION, ANALYSIS AND DISSEMINATION OF USER FEEDBACK

(71) Applicant: Farhad K. SAFAIE, Vienna, VA (US)

(72) Inventor: Farhad K. SAFAIE, Vienna, VA (US)

(21) Appl. No.: 14/190,610

(22) Filed: Feb. 26, 2014

Related U.S. Application Data
(60) Provisional application No. 61/769,270, filed on Feb. 26, 2013.

(51) Int. Cl. G06F 17/30

(52) U.S. Cl. CPC G06F 17/30648; G06F 17/3053; G06F 17/30864

(57) ABSTRACT

A method of collection, dissemination, storage, and analysis of user feedback is disclosed. A plurality of user touchpoints are defined where user feedback is desired. A unique code is associated with each of the defined user touchpoints. Upon determining that a user is at one of the defined user touchpoints, the method includes sending a user feedback request to the user. If the user provides feedback, the user feedback is transmitted to the terminals of responsible entities within the organization. The responsible entities may take any corrective action needed in response to the user feedback at the user touchpoint. The user feedback and any action taken in response to the user feedback are also stored in a remote database for further analysis.

### CROSS-REFERENCE TO RELATED APPLICATIONS

This patent application claims priority to U.S. Provisional Patent Application No. 61/769,270 filed on Feb. 26, 2013, the entire content of which is hereby incorporated by reference.

### BACKGROUND

1. Field

The present disclosure relates generally to methods and systems for collecting, disseminating, managing, analyzing, and benchmarking of user feedback to improve user experience at various points of interaction between an organization and a user.

2. Description of Related Art

Most organizations (public or private) strive to improve their users' experience. Most organizations explicitly include their users (and their satisfaction) as an element in their mission or strategy. These organizations either intuitively know or are scientifically convinced that there is a positive correlation between their users' experiences and their key business outcomes. For example, past studies have established the correlation between customer experience and revenues (See, Michael Luca, “Reviews, Reputation, and Revenue”, September 2011, Harvard Business School).

Typically, when a user receives a service or a product from an organization, such as at a restaurant or a retail store, the user forms an opinion about the service or product received. A user may receive exceptional or poor service or product, which may influence the user's willingness to return for that service or product. User opinions may also influence others to whom the user offers his/her opinion (e.g., friends, family, etc.), particularly after the advent of social media and experience postings and rating entities. Many organizations rely on customer surveys or “mystery shoppers” to gauge user satisfaction.

Customer surveys are generally conducted by organizations to collect user feedback after a user receives their products and/or services, either through a paper survey presented to the customer in-store or sent through the post, or through an electronic mean such as e-mailing them links to survey sites, kiosks, websites, etc. Regardless of the delivery mechanisms, these customer surveys pose a number of challenges. For instance, these surveys usually consist of long lists of questions designed to capture all aspects of a user experience including in some instances experiences that traverse a number of user touchpoints. Due to the length of most traditional surveys, majority of users are unwilling to complete them. Users are generally interested in expressing their opinions about one or two specific touchpoints that were important to them.

For instance, consider the scenario of air travel. Air travel involves several major stages for the passenger: Reservation, Baggage Check-in, Passenger Check-in, Boarding, Flight, and Baggage Claim. Passengers are usually asked to respond to a long passenger satisfaction survey after the passenger has gone through all these stages, as depicted in FIG. 1.

In this case, the passenger may wish to rate only a specific touchpoint based on a different set of criteria than those included in the customer satisfaction survey. Furthermore, the passenger may wish to rate their interaction with the service provider at a particular stage of their air travel right after the interaction. However, that interest may diminish by the end of the air travel and may not overcome a reluctance to complete a long customer satisfaction survey. Similarly, rating the different stages at the conclusion of air travel via passenger satisfaction surveys may also require the passenger to remember specifics about the service providers. Further, delay in providing feedback about a particular service that the passenger received affects the usefulness of the feedback as there is no opportunity for an entity or service provider to address undesirable situations shortly after the experience, so that the subsequent passenger are not negatively impacted by those situations.

In some instances, the user may be unable to remember or find the exact location where the service was received. For example, restaurant chains may have several locations within a five-mile radius, in which case remembering exactly which one was visited may be a challenge.

Furthermore, many organizations have difficulties making the user feedback available to staff and management in a timely and/or meaningful fashion, or holding them accountable and responsible for addressing the issues that may be raised in the surveys, particularly when there is ambiguity about who at the service provider was responsible for the experience.

“Mystery shoppers” are individuals who pose as customers and document their experience by filling out a survey. In addition to the shortcoming of customer satisfaction surveys, mystery shoppers are proxies for customers, and their perceptions may not accurately reflect those of real customers.

Thus, the prior systems present technological problems in timely and effectively capturing user experiences. Thus, there is a need for a technological solution that facilitates capturing user feedback when the user chooses to share at the various touchpoints without substantial delay between the user's interaction with the touchpoint and the time of collecting the user feedback. Further, there is a need to disseminate the feedback to the relevant staff in the organization, ideally in time to react appropriately to the feedback. Furthermore, the senior management in the organization needs tools to hold staff and management accountable for managing user experience with touchpoints within their areas of responsibility.

### SUMMARY

In one aspect, disclosed herein is a method for codifying and storing in a database key attributes of an organization, its sub-organizations, staffing in each of its sub-organizations, and the responsibility of each staff member with respect to the touchpoints that are the responsibility of the sub-organization. This information, among other uses, can be used for analysis, benchmarking and dissemination of feedback collected at user touchpoints.

In another embodiment, disclosed herein is a method of analyzing user feedback obtained using at least one communication module comprising defining a plurality of user touchpoints and storing them in a database, associating a unique code with each of the stored plurality of user touchpoints, determining whether a user is at one of the stored plurality of user touchpoints, providing a communication to the at least one communication module at each of the plurality of user touchpoints requesting user feedback via the at least one communication module when the user is at or is interacting with one of the stored plurality of user touchpoints, receiving user feedback via the at least one communication module, the user feedback including the unique code, determining a terminal of at least one responsible entity based on the unique code included in the received user feedback, and routing the received user feedback to the terminal of the at least one responsible entity.

In another embodiment, the at least one communication module may be one of a server on a network providing a website, or an email providing a link to a website or requesting feedback, an instant message communication mean, a phone call communication mean, a tweet communication mean providing a dialogue for requesting feedback, or an electronic interface provided at the user touchpoint requesting feedback.

In still another embodiment, it is determined that a user is at one of the plurality of user touchpoints based on one of visual feedback from a camera, a biometric scanner, or a location detection device such as a GPS device within the user's mobile application.

In still another embodiment, the received user feedback is in the form of a rating and/or comments.

In still another embodiment, the responsible entity is at least one of a service provider, an entity responsible for management of one of the plurality of user touchpoints, and an entity responsible for management of all of the plurality of user touchpoints.

In still another embodiment, the method further comprises storing the received user feedback in a remote database. In still another preferred embodiment, the method further comprises sorting the received stored user feedback based on a plurality of attributes, the plurality of attributes including at least one of the ratings, comments, the service provider, product, function, and service. In another embodiment, the comments are analyzed through sentiment analysis tools or other tools to categorize the feedback based on the level of user satisfaction, the aspect of touchpoint commented on, or other categorization criteria. In still another preferred embodiment, an action taken in response to the stored user feedback is also stored in the remote database.

Other aspects of the invention will be apparent from the following description and the claims.

### BRIEF DESCRIPTION OF DRAWINGS

In the accompanying drawings, shown are certain present exemplary embodiments of the user feedback collection, dissemination, and assessment method of the present disclosure in which:

FIG. 1 is an overview of the methodology of the present disclosure;

FIG. 2 is a block diagram illustrating the system architecture for a system in which embodiments of the present disclosure may be implemented;

FIG. 3 is a flow chart illustrating the logical diagram for a system in which embodiments of the present disclosure may be implemented;

FIG. 4A is a flow chart illustrating the logical diagram for a system in which embodiments of the present disclosure may be implemented;

FIG. 4B is a flow chart illustrating the logical diagram for a system in which embodiments of the present disclosure may be implemented;

FIG. 5A exemplifies the use of traditional long surveys in air travel;

FIG. 5B exemplifies capturing short touchpoint feedback and disseminating the information to staff and management in air travel in accordance with exemplary embodiments;

FIG. 6 is a block diagram illustrating several major components of the present disclosure and the ability to interact with other systems (e.g., CRM, employee directory, etc.) in various organizations;

FIG. 7 is a diagram illustrating an example of an organizational breakdown and touchpoints in accordance with exemplary embodiments;

FIG. 8A is an example of a feedback page in accordance with exemplary embodiments;

FIG. 8B is an example of a touchpoint feedback form in accordance with exemplary embodiments;

FIG. 9 is an example of identification, and categorization of touchpoints for air travel in accordance with exemplary embodiments; and

FIG. 10 depicts an example computer system in which embodiments of the present disclosure may be implemented.

### DESCRIPTION OF EXEMPLARY EMBODIMENTS

A “user”, as used herein, means any entity that interacts with an organization. By way of example, the user may be a customer, patient, guest, passenger, shareholder, stakeholder, client, employee, management, or supplier. A person possessing ordinary skill in the art would understand that the user is not limited to the above examples and may be defined as any person, group, or any physical or legal entity that interacts with an organization.

An “organization”, as used herein, means any entity private or public, for profit or non-profit, legal or physical. By way of example, the organization may be a restaurant chain, a government agency, a charity, a church, a town, a family, or an individual. A person possessing ordinary skill in the art would understand that an organization is not limited to the above listed examples and may be defined as any entity with which others interact.

A “user touchpoint,” as used herein, means temporally and sometimes geographically separated points of contact between a user and an entity, wherein a plurality of touchpoints forms one continuous transaction. The user touchpoints may be defined at nearly any of a plurality of locations, functions, services or products where user feedback is desired. For instance, the stored user touchpoints may be an interaction of a user with at least one element of an organization, such as a product, a service, a location, a function, or a service provider. For example, an interaction point between a user and an element of an organization can be a defined touchpoint. For instance, user touchpoints may be defined as a staff member fulfilling a particular role such as a sales person, a waiter, or an executive who provides a service to the user; a product such as a car, a meal, a software application; a service such as Wi-Fi internet service at an airport or package delivery service; or a facility such as a movie theater, a restaurant or an ice skating rink. A person skilled in the art would understand that the user touchpoint is not limited to the above examples and may be defined as any location, object or event where receiving user feedback is desired.

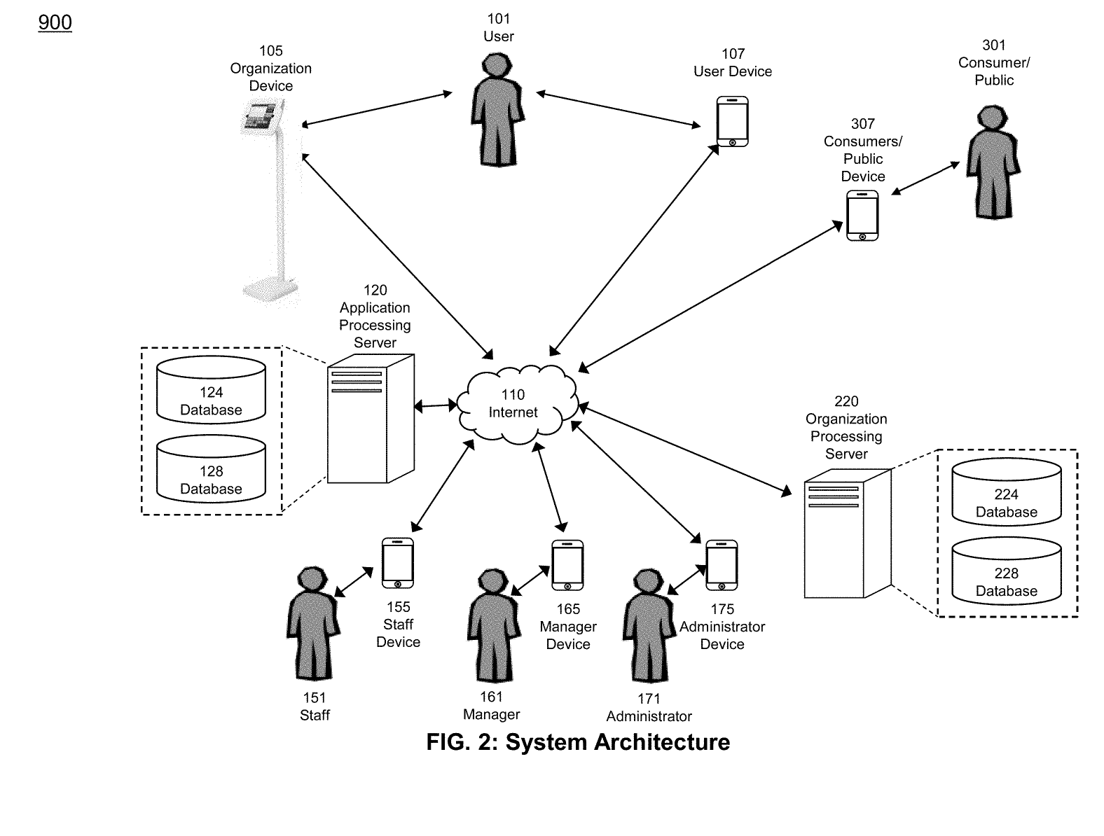

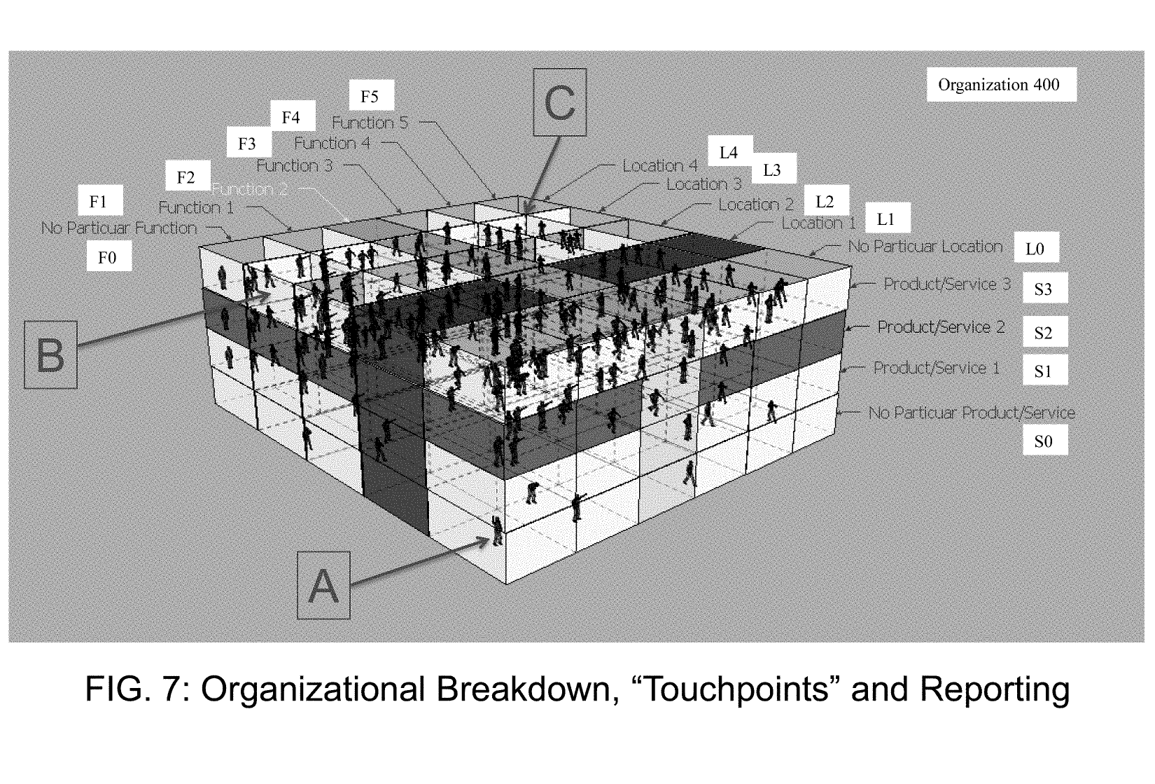

A “communication module,” as used herein, means any device which may be used to transmit a communication at the user touchpoint requesting user feedback, and to transmit the received user feedback to a remote database and/or a terminal of the responsible entities. In one embodiment, the communication module may be the user's mobile phone (e.g., the consumer device 107 shown in FIG. 2 discussed below) which may receive an email, a Tweet, or an instant message including a link sent to the user after the user's interaction with a touchpoint, which upon being clicked on by the user redirects the user to an online survey. In another embodiment, the communication module may be a server on a network providing the organization desiring feedback's webpage where the user can select a link from the organization's website to provide feedback on a representative of the organization, a location, a function, a product, a service, or a service provider. In other embodiments, the communication module may be a tablet or a kiosk (e.g., organization device 105 shown in FIG. 7 discussed below) provided by the organization for capturing the feedback for a specific touchpoint, which the user may access to provide their feedback if desired. In one embodiment, the user may use a mobile phone or tablet to scan a Quick Response (QR) tags provided by the organization at the specific user touchpoint to access a link where the user can provide feedback. In still another embodiment, the user may use a mobile phone or tablet to scan Near Field Communication (NFC) tags to receive the link for providing feedback for a particular user touchpoint.

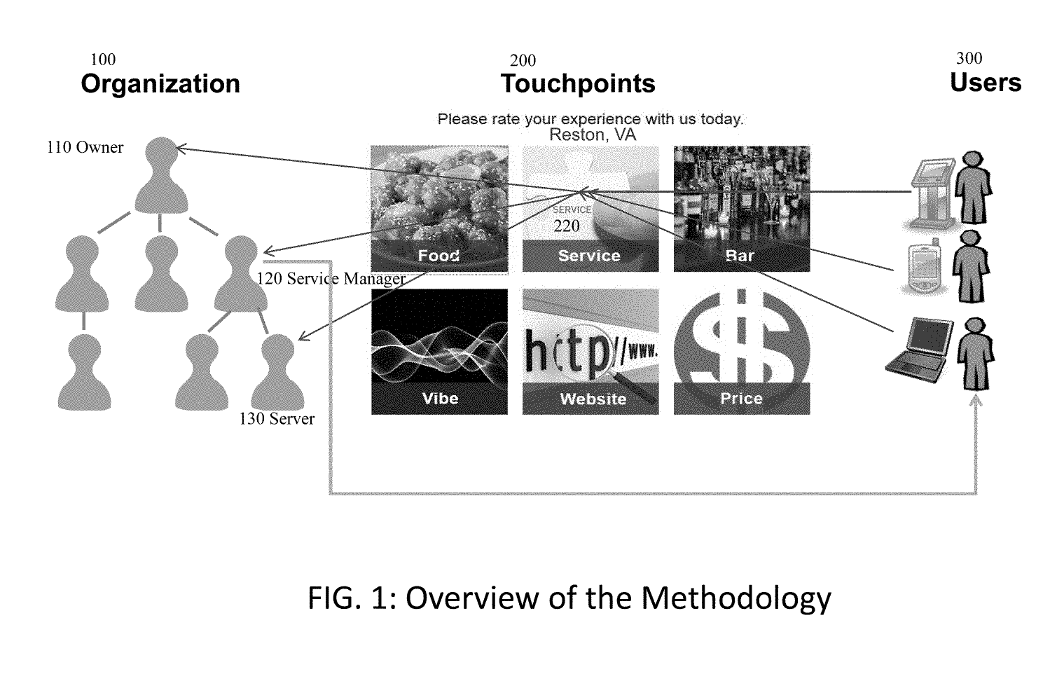

FIG. 1 provides an overview of the methodology in the embodiments of the present disclosure. Users 300 can provide feedback using their own or organization's devices to provide feedback on any and all touchpoints 200 for organization 100. The feedback provided for a touchpoint, such as server 130, will be analyzed and disseminated to server 130, the service manager 120, and the owner 110. The service manager 120 or the owner 110 can communicate back with the user.

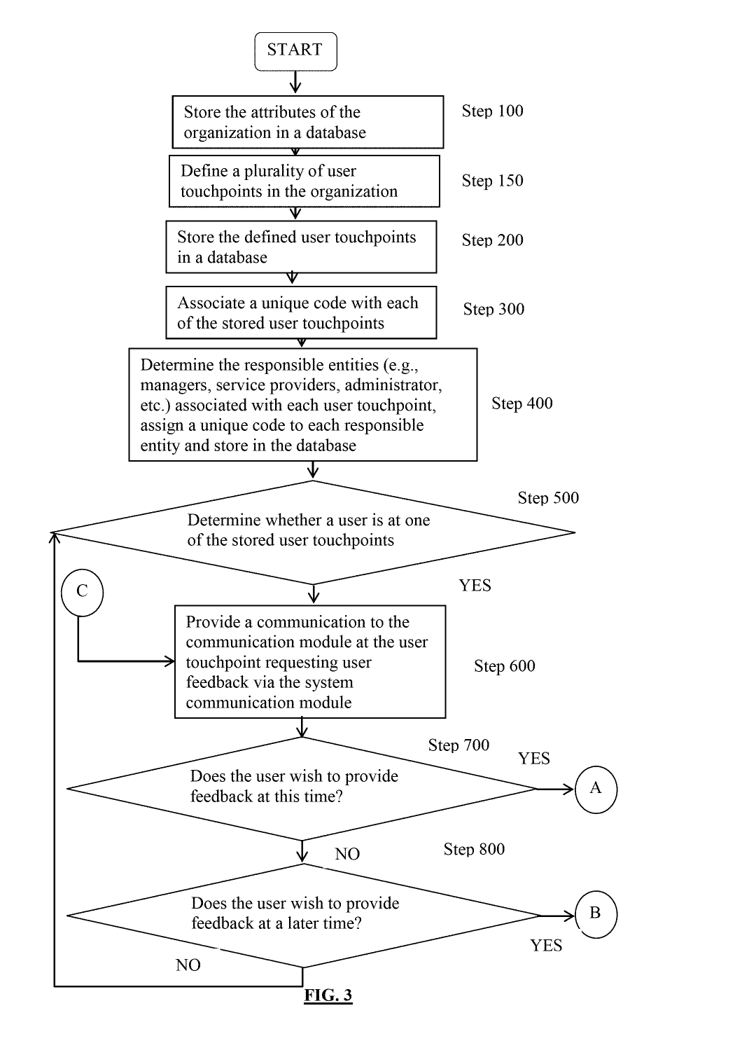

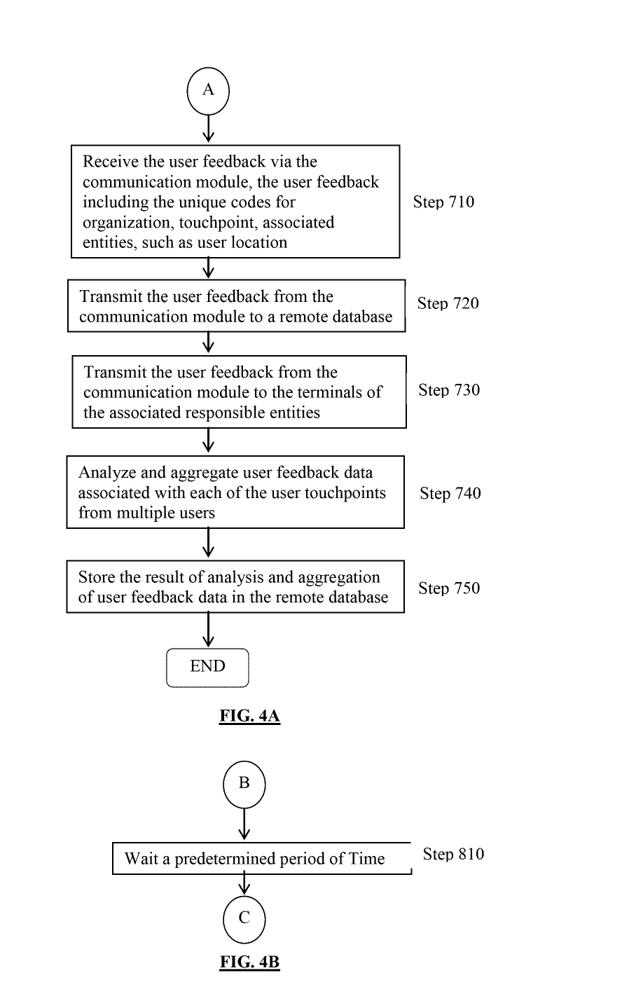

FIG. 2 is a block diagram illustrating the architecture of a computer system (900) in accordance with exemplary embodiments. It illustrates capturing touchpoint-feedback from a user (101), processing by application server (120) and delivering to the staff (151), management (161), and administrator (171) in the organization. Further, the responses from and actions by staff and management are recorded in the application databases (224, 228). Administrators (171) perform the administrative tasks in the system (e.g., setting up users and their privileges). The system architecture shown in FIG. 2 will be described below in conjunction with the exemplary embodiment shown in FIGS. 3, 4A, and 4B.

FIG. 3 shows a flow chart for collecting user feedback in accordance with one of more embodiments of the invention. Initially, the attributes (industry segment, locations, products, services, functions, staff, management, etc.) of the organization are defined at Step 100. Next, a plurality of user touchpoints are defined by the organization collecting user feedback at Step 150. For instance, the staff 151, manager 161, and/or the administrator 171 may define the various user touchpoints as desired at the application processing server 120. The various defined user touchpoints are next stored in databases 124, 128 at Step 200.

Next, at Step 300, a unique code associated with each of the defined plurality of user touchpoints. The “unique code,” as used herein, means an identifier used to identify the user touchpoint. In one embodiment, the unique codes may embody an industry wide product coding, such as Universal Product Code (UPC) or an organization's product coding, such as an item number. In another embodiment, the unique code may be included in a URL link sent to the user requesting feedback, where the user can select a link from the organization's website to provide feedback on a touchpoint, a location, a function, a product or a service. In another embodiment, the unique code may be incorporated in dedicated text message numbers or unique four digit numbers associated with each of the stored plurality of user touchpoints. In another embodiment, the unique code may be in the form of a unique hash tag in a case where the user feedback is provided via a tweet or the like.

Continuing with FIG. 3, at step 400, responsible entities associated with each of the various user touchpoints are determined and stored in the databases 124, 128. A “responsible entity,” as used herein, means any individuals or entities that are associated with the particular user touchpoint. An organization may be divided into a plurality of organizational units to ensure that the collected user feedback is disseminated to the responsible entities. An “organizational unit,” as used in this example, means a part of an organization that has its own management, but can be any demarcation deemed appropriate under the circumstances. For instance, organizational units may be a co-located unit, such as one at a store, at a restaurant, or in a state; a functional unit, such as engineering, legal, or finance, a product or a service unit, such as a computer application team or a tax preparation group, and an associated group, such as suppliers or contractors, to name just a few examples of the near limitless possibilities. Individuals in each organizational unit may be set up in the system as staff 151, a manager 161, and/or an administrator 171. Administrators 171 can set up users and their privileges within one or more organizational unit. The staff 151 has direct interaction with the users 101 and as such they are user touchpoints and need to be assigned to none, one or more organizational unit. Managers 161 have authority over one or more organizational units.

Next, at step 500, it is determined whether the user 101 is at one of the various defined user touchpoints. The presence of a user 101 at the plurality of user touchpoints may be determined based on receiving IR sensors or visual feedback from a camera located at the user touchpoint in instances that the feedback is to be conveyed through a co-located device. In an embodiment, a biometric scanner may be used to determine the presence of a user at the defined user touchpoint, when the user's identity can be used to create a communication path (e.g., knowing the persons mobile device address or telephone number).

In other embodiments, a location detection device such as a GPS device within the user's mobile application may be used to determine the presence of a user at the defined user touchpoint. For instance, the user may download a mobile application of the organization on his/her mobile phone. The application may use the mobile phone's GPS locator to determine when the user is in the vicinity of the defined user touchpoint. The mobile application, upon determining that the user 101 is at one of the defined user touchpoint may request the user to provide feedback. In this case, the mobile application may check the user device to determine whether the user 101 is physically present at a user touchpoint for which the user 101 may want to provide feedback data. Said another way, the mobile application may track the user's location and provide the user with a feedback request when appropriate. Alternatively, in one or more embodiments of the invention, the user 101 may initiate the feedback request by indicating to the mobile application that the user 101 is at a location for which the user wants to provide feedback data.

If, at Step 500, it is determined that the user 101 is at one of the defined user touchpoints, a communication requesting user feedback is sent to the organization device 105 and/or the consumer device 107 (i.e., the communication module) (Step 600). As discussed above, the communication requesting user feedback has the unique code included in it. In one embodiment, the communication is generated by the application processing server 120 and sent to the organization device 105 over a communications network (e.g., internet connection 110 as shown in FIG. 2). In other embodiments, for instance, where the communication module is the consumer device 107, the communication requesting the user feedback may be sent in an instant message via a cell tower to the consumer device 107.

The user feedback request may provide the user 101 with the option to provide the feedback at that time (Step 700). In one embodiment, user feedback request may provide the user 101 with the option to provide the feedback at a later time (Step 800) or to decline the user feedback request. In one embodiment, the message accompanying the user feedback request may be customizable by the organization.

If the user 101 wishes to provide feedback at the user touchpoint, the user may do so using the communication module (e.g., the consumer device 107 or the organization device 105). FIG. 4A shows a flowchart showing the steps involved in receiving and dissemination the user feedback. The user 101 provides feedback data associated with the user touchpoint (Step 710). Specifically, using the communication module (consumer device 107 or the organization device 105), the user 101 completes the feedback request associated with the user touchpoint. As described above, the feedback request is associated with the unique code identifying the user touchpoint.

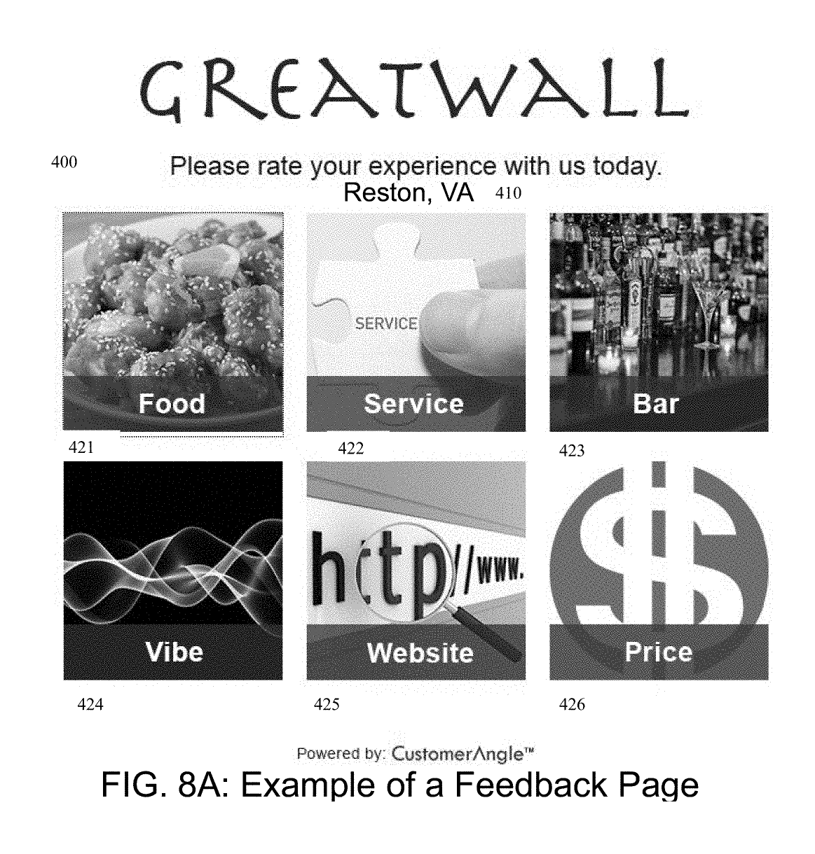

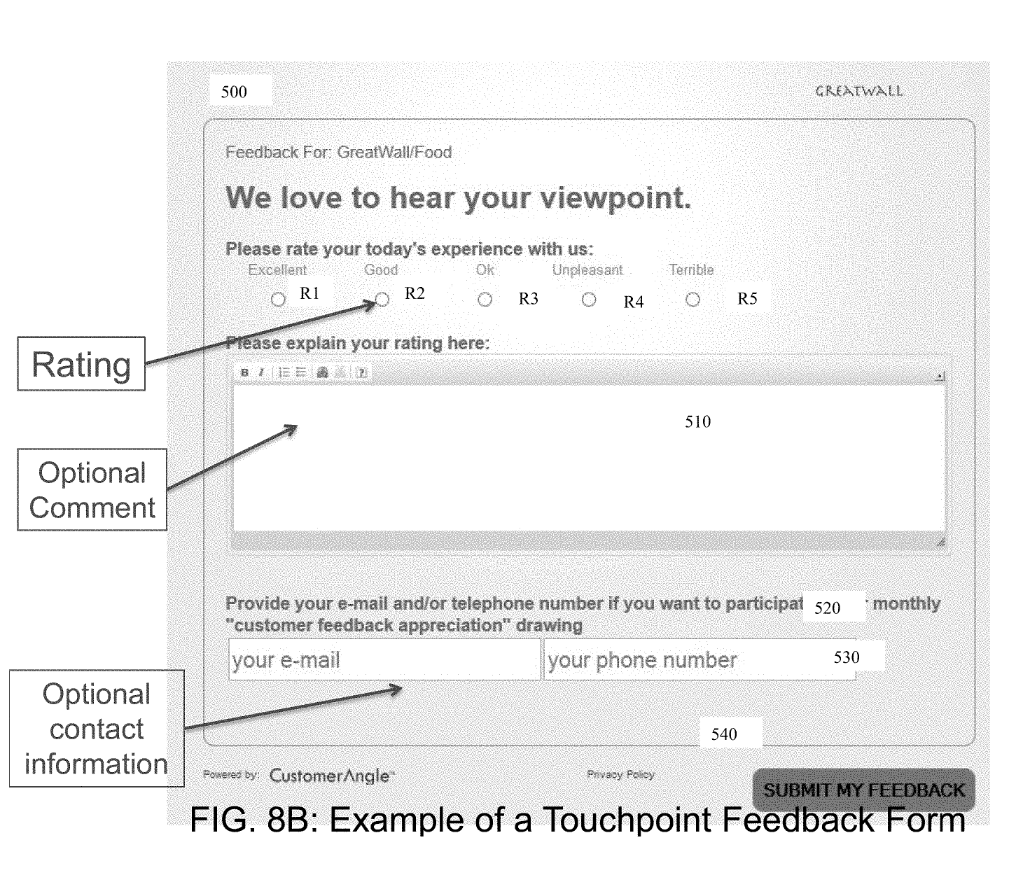

When the user 101 chooses to provide feedback on any touchpoint through one of the available communication modules, the feedback may consist of a rating and an optional comment. In an embodiment, the user experience is captured through a numerical rating (e.g., one to five stars), and an optional comment to explain the rating, as shown in FIG. 8B (discussed later). In another embodiment, the system may capture only a comment and assign a rating (e.g., positive, natural, or negative) based on the analysis of the text in the comment. In still another embodiment, the user may also have an option to provide contact information if he or she is interested in being informed of actions taken within the organization in response to the user's feedback. In still another embodiment, more than one question about a touchpoint may be asked, and the responses be consolidated to one aggregated rating and to one combined comment. A person with ordinary skill in the art would appreciate that the information requested from the user may be customizable in a variety of ways by the organization. By way of example, an explanation for each of the numerical ratings may be provided.

Continuing with FIG. 4A, the user's feedback data, once collected, is immediately transmitted from the communication module to the terminals of the responsible entities (Step 720). As discussed above, the responsible entities are determined and stored in the databases 124, 128 and are associated with the unique codes included in the user's feedback data. In an embodiment, the feedback of the user (the rating and the optional comment) may be transmitted in real time to the terminals of the responsible entities that are associated with that touchpoint (e.g., the staff device 155, manager device 165, and administrator device 175). The terminal may be a computer, tablet, watch, glasses or mobile phone associated with the responsible entity. Alternatively, the user feedback data is stored and transmitted via a wired (or wireless) network once an active network is reached. In one or more embodiments of the invention, the user feedback data is transmitted wirelessly to the terminals of the responsible entities.

The user feedback may simultaneously be transmitted to the organization processing server 220 via a wired (or wireless network) (Step 730). At this stage, the organization processing server may aggregate the feedback data associated with the user touchpoint from multiple users (Step 740). Finally, the remote database stores the aggregated feedback data associated with the user touchpoint (Step 750). The aggregated feedback data associated with the user touchpoint may be made accessible to the various responsible entities for future analysis.

The method may further comprise analyzing the feedback as they are received. In one embodiment, the feedback may be analyzed to provide various statistical attributes (averages, mean time between failures, etc.) of the ratings of individual touchpoint, or of an organizational unit. Text and/or sentiment analysis of the comments for an individual touchpoint (or of an organizational unit) may also be provided in other embodiments. The stored received user feedback and the analysis of the user feedback may be accessible by the various responsible entities within an organization or organizational units.

Further, any action taken in response to a user feedback may also be stored in the remote databases 224 and 228. The stored actions may also be accessible by the various responsible entities within an organization or organizational units over a wired (or wireless) network. In one embodiment, the received user feedback is made accessible to the public 301 via consumers/public devices 307. The responsible entities (for instance, managers 161 and administrators 171) of the organization may provide their responses to the user feedback thereby increasing transparency and improving user experience. In other embodiments, Managers can use the contact information, if provided by the user, and provide update(s) to the users as actions are taken in response to the feedback.

When connected with an organization processing servers 220, other key business metrics (e.g., revenues and expenses) can be compared with and analyzed in conjunction with the user experience metrics for an organizational unit.

Continuing with FIG. 3, the user 101 may wish to provide feedback at a later time (Step 800). In that case, the application processing server 120 may wait a predetermined amount of time before sending another communication via the communication module to the user (Step 810 shown in FIG. 4B). Those skilled in the art will appreciate that the predetermined amount of waiting time may be preset at the application processing server. Alternatively, the user 101 may access the original communication received via the communication module at a later time to provide their feedback. As described above, the feedback request is associated with the unique code identifying the user touchpoint. Thus, even if the user 101 completes the feedback request received at the user touchpoint while the user is no longer physically present at the user touchpoint, the feedback data is correctly associated with the user touchpoint because the unique code is included in the communication requesting the user feedback itself.

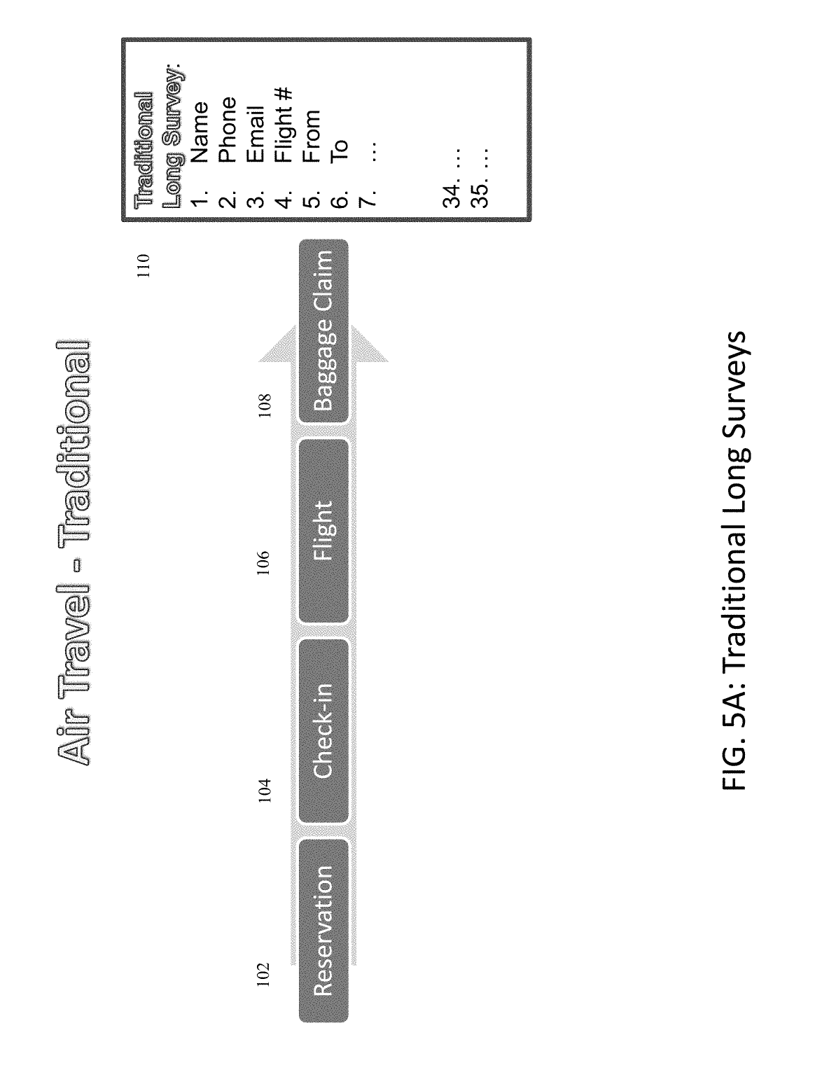

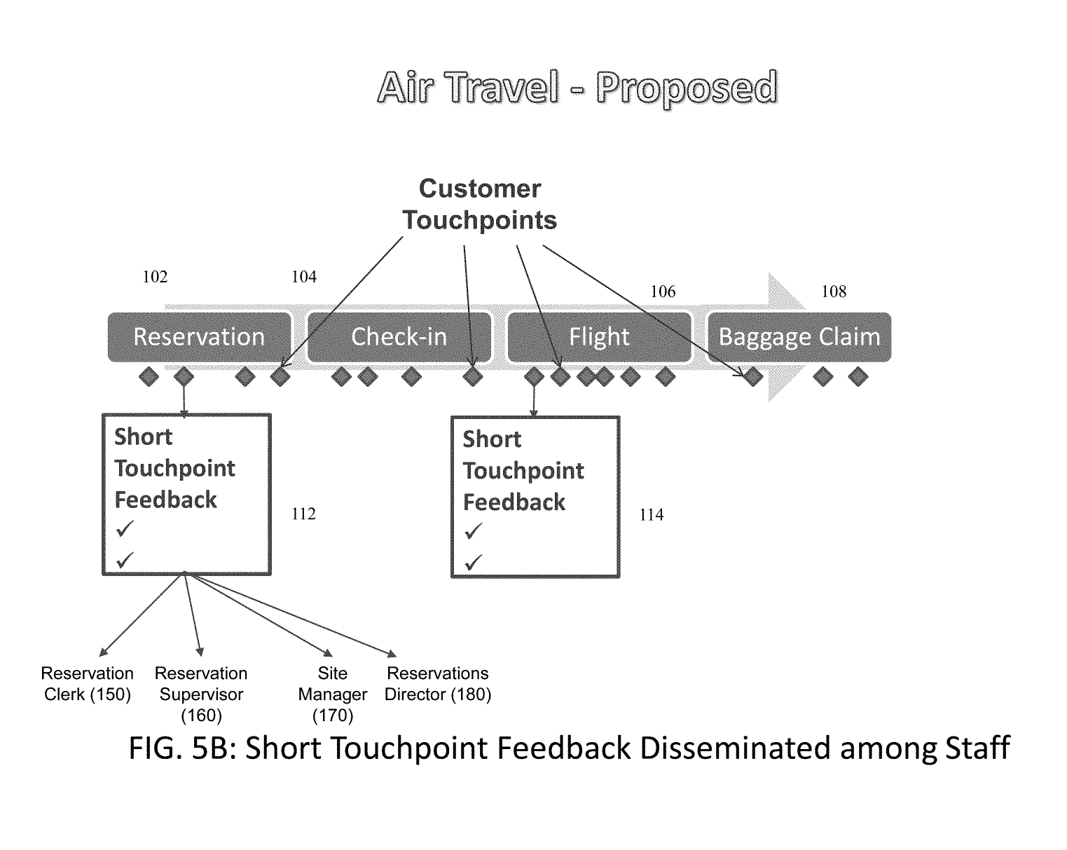

The computer system 900 using hardware, software, firmware, non-transitory computer readable media having instructions stored thereon, or a combination thereof, and may be implemented in one or more computer systems or other processing systems. Hardware, software, or any combination thereof may embody modules and components used to implement the methods of FIGS. 5A-9.

Referring to FIGS. 5A-9, an exemplary embodiment of a method for collection, dissemination, and analysis of user feedback is depicted. FIG. 5A shows an example of a traditional method for receiving user feedback at an airport. Typically, the passenger passes through the reservation system 102, check-in 104, the flight 106, and the baggage claim 108 only to receive a lengthy customer survey 110 at the end of the trip requesting feedback on the passenger's experience. The passenger responses in these customer surveys 110 may not be completed or may be inaccurate due to the long delay between the passenger's interaction with the user touchpoint and the time when the survey is filled out.

FIG. 5B is an example of the presently disclosed method of collecting and disseminating user feedback during air travel. A plurality of user touchpoints are defined and stored in a database at the multiple points of contact between the user and the organization. The passenger passes through the reservation system 102, check-in 104, the flight 106, and the baggage claim 108. The passenger may receive a short touchpoint feedback request (112, 114) at one or more of the user touchpoints, thereby eliminating the problems associated with length customer surveys as discussed above with regard to FIG. 5A. Each user touchpoint in the organization needs to be identified. These touchpoints may include all the staff members with the “Service Provider” role. Additionally, in an embodiment, the user touchpoints may include products, services or assets of the organization that is used by users.

The feedback collected at the various user touchpoints is transmitted to the terminals of the responsible entities. FIG. 5B, for instance, shows the user feedback being transmitted to the terminals of the reservation clerk 150, the reservation supervisor 160, site manager 170 and the reservations director 180.

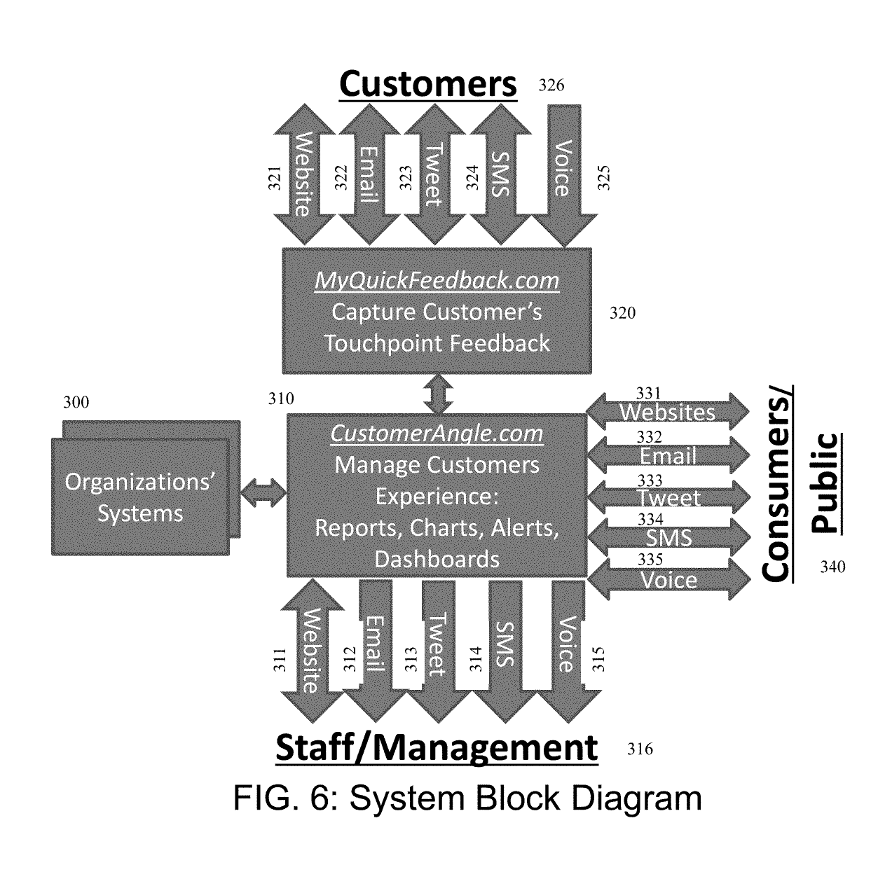

FIG. 6 shows a block diagram illustrating several major aspects of the present disclosure. In the exemplary embodiment shown in FIG. 6, the customers 326 provide their feedback in a communication sent via a website 321, an email 322, a tweet 323, an instant message 324, or a phone message 325. The received user feedback is collected, aggregated and analyzed at servers 310 and are made available to the organization 300, staff and/or management 316, and, if chosen by the organization, to the consumers/public 340 for review. Specifically, the received user feedback may be transmitted to the terminals, e.g., a mobile device, of the staff and/or management 316 via a website 311, an email 312, a tweet 313, an instant message 314, or a phone message 315. Similarly, the users 325 may be able to access the aggregated feedback at the server 310 via a website 331, or receive the aggregated feedback from the server 310 via an email 332, a tweet 333, a text message 334, or a phone call 335.

The received user feedback may be stored in the remote database and made accessible to the organization 300, staff and/or management 316, and, if chosen by the organization, to the consumers/public 340 for review for a predetermined amount of time. In one aspect, the organization 300, staff and/or management 316, and, if chosen by the organization, the consumers/public 340 may be provided access to the aggregated data for the previous day, week, month, a year, or any other period of time as desired.

The received user feedback, after being collected and aggregated, may be analyzed and presented to the organization 300, staff and/or management 316, and, if chosen by the organization, to the consumers/public 340 in a variety of ways. By way of example, the received user feedback may be sortable by the date, time, location, rating, the specific user touchpoint, or the specific element of the organization (for instance, as discussed below with reference to FIG. 7). The received user feedback may further be analyzed and presented in the form of charts, graphs, or other known forms of visual representation of the data. The charts, graphs, etc., may represent the received user feedback data for the previous day, week, month, a year, or any other period of time as desired.

FIG. 7 is a diagram illustrating an example of organizational breakdown. In this example, the organization is broken down into locations, functions, and products/services axes. In other words, the organization 400 is broken down into five locations (L0-L4), six functions (F0-F5), and four products/services offered (S0-S3). The organization breakdown may be further extended to sub locations (e.g., country, state, region), or sub functions (e.g., accounts payable team within the finance function), or elements of products/services (e.g., product parts, service steps, channels, media). In an embodiment, additional breakdown axes, such as operating companies or business units, may be used for breaking down larger organizations. In other embodiments, fewer breakdown categories can be used for smaller organization.

In accordance with an exemplary embodiment of the present disclosure, responsible entities for the various user touchpoints may be determined based on the organizational breakdown shown in FIG. 7. For example, for a user touchpoint defined at point B, any received user feedback will be transmitted to responsible entities at the location L3, who provide a service or product S3. In the embodiment shown in FIG. 7, the user touchpoint B is not associated with any particular function.

Similarly, for the user touchpoint defined at point C, any received user feedback will be transmitted to responsible entities at the location L4, who provide a service or product S3, and serve a function F5. Such organization feedback would reduce the response time for a responsible entity to address any issues raised in the received user feedback, preferably to the period that the user is still at the user touchpoint.

FIGS. 8A and 8B show an example of a touchpoint feedback page 400 and form 500 in accordance with exemplary embodiments. The user selects the touchpoint that he or she wants to provide feedback on through one or several feedback pages 400. When the user chooses to provide feedback on any touchpoint through the communication module, the feedback may consist of a rating and an optional comment. In the exemplary embodiment shown in FIG. 5A, the user may provide a rating (R1-R5) and/or leave a comment in the comment box 510 explaining the rating. The user may also optionally provide their contact information (e.g., providing an email address in box 520 or a phone number in box 530) if he or she is interested in being informed of actions taken within the organization in response to the user's feedback. In other embodiments, the user experience may be adequately captured through a numerical rating (e.g., one to five stars). In still other embodiments, the system may capture only a comment and assign a rating (e.g., positive, natural, or negative) based on the analysis of the text in the comment.

In still other embodiments, more than one question may be asked about a touchpoint, and the responses be consolidated to one aggregated rating and to one combined comment by the organization processing server 220. However, additional questions reduce the attraction of the approach to users (as it would take more time to respond). In one aspect, the user may provide the name of the service provider along with the comments and/or ratings.

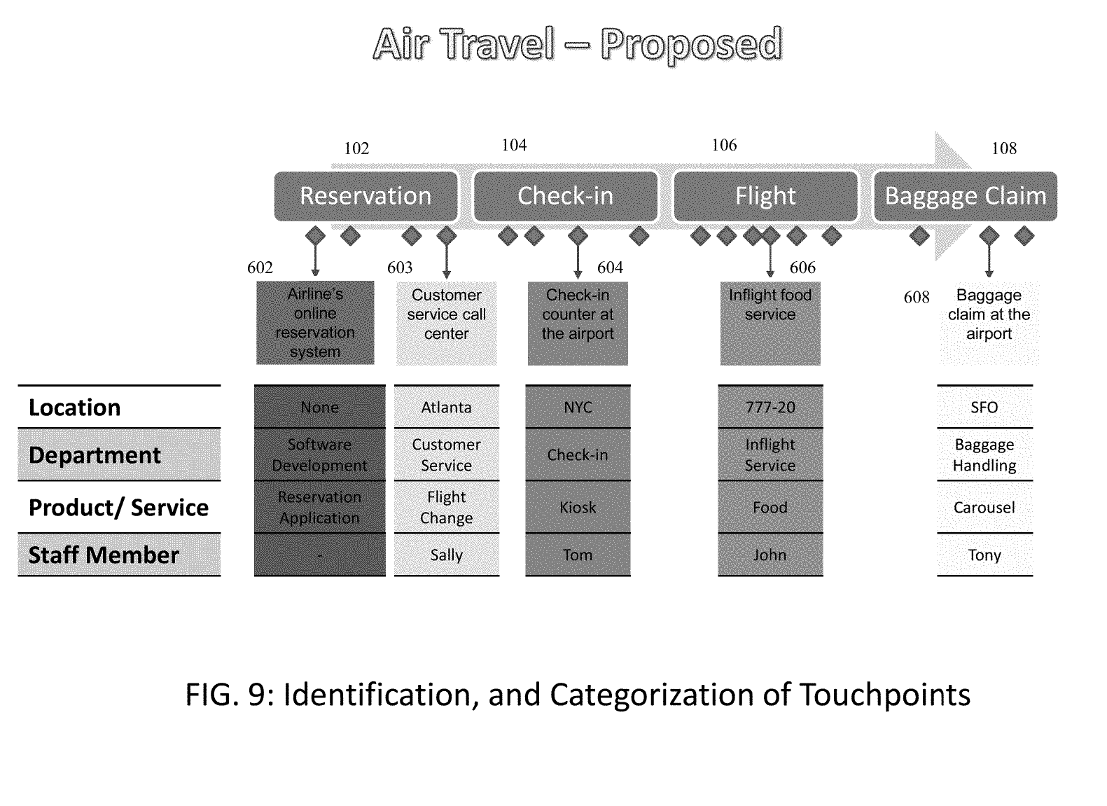

FIG. 9 is a diagram illustrating an example for identifying and categorizing user touchpoints in an organization in accordance with exemplary embodiments. In this example for an airline, the entire air travel experience is broken down into major steps: reservation 102, check-in 104, flight 106 and baggage claim 108. Then, touchpoints in each major step are identified. For example, in air travel experience shown in FIG. 6, the following touchpoints may be identified: (i) airline's online reservation system 602; (ii) customer service call center 603; (iii) check-in counter in the airport 604; (iv) inflight food service 606; and (v) baggage claim at the airport 608. Additional user touchpoints may also be defined if user feedback is desired at a particular point of contact.

A person skilled in the art would understand that the method discussed above may be applied in similar manners to capture user feedback in various other scenarios. A non-limiting list of such scenarios is listed below for illustrative purposes:
Employee Feedback: To capture, analyze, and disseminate employees' comments/feedback on any aspect of their organization.
Supplier Feedback: To capture, analyze, and disseminate suppliers' comments/feedback on any aspect of their client organization.
Guest Feedback: To capture, analyze, and disseminate guests' comments/feedback on any aspect of their host organization.
Client Feedback: To capture, analyze, and disseminate clients' comments/feedback on any aspect of their supplier organization.
Patient Feedback: To capture, analyze, and disseminate patients' comments/feedback on any aspect of their healthcare provider organization.
Management Angle: To provide a dashboard to an organization's stakeholders' feedback, with the ability to drill down in the performance of an individual service provider, product, office (location), or department (function).

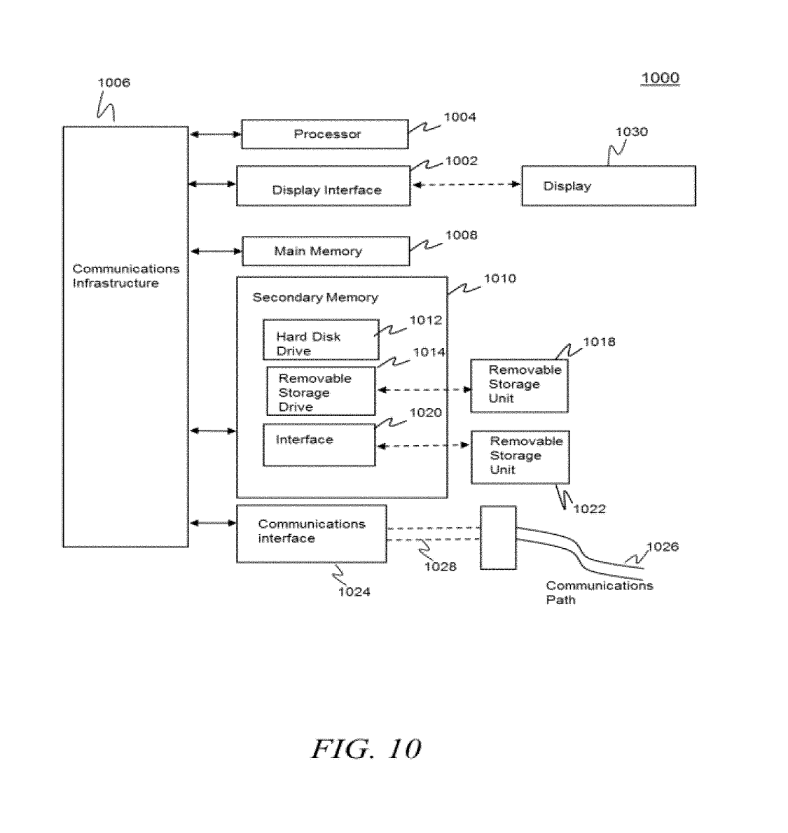

FIG. 10 illustrates an exemplary computer system 1000 in which embodiments of the present disclosure, or portions thereof, including but not limited to the central control system, may be implemented as computer-readable code. For example, the various aspects of the central control system can be implemented in computer system 1000 using hardware, software, firmware, non-transitory computer readable media having instructions stored thereon, or a combination thereof, and may be implemented in one or more computer systems or other processing systems. Hardware, software, or any combination of such may embody any of the modules and components used to implement the central control system described above.

If programmable logic is used, such logic may execute on a commercially available processing platform or a special purpose device. One of ordinary skill in the art may appreciate that embodiments of the disclosed subject matter can be practiced with various computer system configurations, including, but not limited to, multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor cores.

Various embodiments of the present disclosure are described in terms of the exemplary computer system 1000. After reading this description, it will become apparent to a person skilled in the relevant art how to implement the central control system of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The computer system 1000 includes a display 1030 connected to a communications infrastructure 1006 via a display interface 1002. In an embodiment, the display 1030, in conjunction with the display interface 1002, provides a User Interface (“UI”) (not shown). The computer system 1000 also includes a processor device 1004 connected to the communications infrastructure 1006. The processor device 1004 may be a special purpose or a general purpose processor device. As will be appreciated by persons skilled in the relevant art, the processor device 1004 may also be a single processor in a multi-core/multiprocessor system, such system operating alone, or in a cluster of computing devices operating in a cluster or server farm. Processor device 1004 is connected to the communication infrastructure 1006, for example, via a bus, a message queue, a network, a multi-core message-passing scheme, etc.

The computer system 1000 also includes a main memory 1008, for example, a random access memory (RAM), and may also include a secondary memory 1010. The secondary memory 1010 may include, for example, a hard disk drive 1012 and a removable storage drive 1014. The removable storage drive 1014 may comprise a floppy disk drive, a magnetic tape drive, an optical disk drive, a flash memory, or the like.

The removable storage drive 1014 may read from and/or write to a removable storage unit 1018 in a well-known manner. The removable storage unit 1018 may comprise a floppy disk, magnetic tape, optical disk, Universal Serial Bus (USB) drive, flash drive, memory stick, etc., which is read by and written to by removable storage drive 1014. As will be appreciated by persons skilled in the relevant art, the removable storage unit 1018 may include a non-transitory computer usable storage medium having stored therein computer software and/or data.

In alternative implementations, the secondary memory 1010 may include other similar means for allowing computer programs or other instructions to be loaded into the computer system 1000. Such means may include, for example, a removable storage unit 1022 and an interface 1020 provided within, for example, the secondary memory 1010. Examples of such means may include, but are not limited to, a program cartridge and cartridge interface (such as that found in video game devices), a removable memory chip (such as an EPROM or PROM) and associated socket, and other removable storage units 1022 and interfaces 1020 which allow software and data to be transferred from the removable storage unit 1022 to the computer system 1000.

The computer system 1000 may also include a communications interface 1024. The communications interface 1024 allows software and data to be transferred between the computer system 1000 and external devices. The communications interface 1024 may include a modem, a network interface (such as an Ethernet card), a communications port, a PCMCIA slot and card, or the like. Software and data transferred via the communications interface 1024 may be in the form of signals 1028, which may be electronic, electromagnetic, optical, or other signals capable of being received by communications interface 1024. These signals may be provided to the communications interface 1024 via a communications path 1026. The communications path 1026 carries signals and may be implemented using wire or cable, fiber optics, a phone line, a cellular/wireless phone link, an RF link, or other communications channels.

In this document, the terms “computer program medium”, “non-transitory computer readable medium”, and “computer usable medium” are used to generally refer to tangible media such as, for example, removable storage unit 1018, removable storage unit 1022, and a hard disk installed in hard disk drive 1012. Signals 1028 carried over the communications path 1026 can also embody the logic described herein. The computer program medium and computer usable medium can also refer to memories, such as, for example, main memory 1008 and secondary memory 1010, which can be memory semiconductors (e.g., DRAMs, etc.). These computer program products are means for providing software to computer system 1000.

Computer programs (also called computer control logic and software) are generally stored in the main memory 1008 and/or the secondary memory 1010. The computer programs may also be received via the communications interface 1024. Such computer programs, when executed, enable the computer system 1000 to become a specific purpose computer able to implement the present disclosure as discussed herein. In particular, the computer programs, when executed, enable the processor device 1004 to implement the processes of the present disclosure discussed below. Accordingly, such computer programs represent controllers of the computer system 1000. Where the present disclosure is implemented using software, the software may be stored in a computer program product and loaded into the computer system 1000 using, for example, the removable storage drive 1014, interface 1020, and hard disk drive 1012, or communications interface 1024.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries and order of these functional building blocks have been arbitrarily defined herein for the convenience of the description. Alternate boundaries and order of steps can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the disclosure is illustrated and described herein with reference to specific embodiments, the embodiments are not intended to be limited to the details shown. Rather, various modifications may be made in the details within the scope and range equivalents of the claims and without departing from the disclosure.

I/We claim:

1. A method of assessing user feedback obtained using at least one communication module, the method comprising:
defining a plurality of user touchpoints;
storing the plurality of user touchpoints in a database;
associating a unique code with each of the stored plurality of user touchpoints;
determining at least one responsible entity based on the unique code and storing the at least one responsible entity in the database;
determining whether a user is at one of the stored plurality of user touchpoints;
providing a communication via the at least one communication module requesting user feedback when the user is at one of the stored plurality of user touchpoints, the user feedback request including the unique code;
receiving user feedback via the at least one communication module; and
transmitting the received user feedback to a terminal of the at least one responsible entity via the plurality of communication modules.

2. The method according to claim 1, wherein the at least one communication module is one of server on a network, a tablet, or a mobile device, and
the communication provided by the at least one communication module may be one of a link to a website, an email, an instant message, a phone call, or a tweet.

3. The method according to claim 1, wherein at least one of a camera, IR sensor, biometric scanner, or a GPS device is used to determine whether a user is at one of the stored plurality of user touchpoints.

4. The method according to claim 1, wherein the responsible entity is at least one of a service provider, an entity responsible for management of one of the plurality of user touchpoints, and an entity responsible for management of all of the plurality of user touchpoints.

5. The method according to claim 1, wherein the terminal of the responsible entity is at least one of a computer, tablet, or cell phone.

6. The method according to claim 1, wherein the user feedback routed to the terminal of the responsible entity is in the form of a rating and/or comments.

7. The method according to claim 6 further comprising:
sorting the received user feedback based on a plurality of attributes, the plurality of attributes including at least one of the ratings, comments, the service provider, product, function, and service.

8. The method according to claim 1 further comprising:
transmitting the received user feedback to a remote database;
storing the received user feedback in the remote database; and
storing an action taken in response to the received user feedback, wherein the database is accessible via the terminal of the at least one responsible entity.

9. The method according to claim 7 further comprising:
storing the sorted received user feedback in a remote database; and
storing an action taken in response to the received user feedback, wherein the database is accessible via the terminal of the at least one responsible entity.

10. A non-transitory computer-readable recording medium having a program stored thereon that causes a processor of a computing device to execute a method of claim 1.

11. A system for assessing and disseminating user feedback obtained using at least one communication module, comprising:
a database in which a plurality of user touchpoints and a unique code associated with each of the plurality of user touchpoints is stored; the database being further configured to store at least one responsible entity based on the unique code;
a determining device configured to determine whether a user is at one of the stored plurality of user touchpoints;
the at least one communication module providing a communication requesting user feedback when the user is at one of the stored plurality of user touchpoints, the user feedback request including the unique code;
the at least one communication module receiving user feedback via; and
the at least one communication module transmitting the received user feedback to a terminal of the at least one responsible entity.
